(19) United States
(12) Patent Application Publication
(10) Pub. No.: US 2006/0133417 A1
(43) Pub. Date: Jun. 22, 2006

(54) Method and system for providing interoperability of different version protocols without access to protocol specific code

(75) Inventors: Michael Cheng, Austin, TX (US); Randy Eugene Fox, Kingsland, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(73) Assignee: INTERNATIONAL BUSINESS MACHINES CORPORATION, ARMONK, NY (US)

(21) Appl. No.: 11/002,698

(22) Filed: Dec. 2, 2004

(51) Int. Cl. H04J 3/16

(52) U.S. Cl. 370/467

(57) ABSTRACT

The present invention is directed to a method and system to preserve interoperability among processes in a distributed system through transformation of in-memory representation of different versions of the same data. When an upgraded process receives data from an un-upgraded process, the old protocol for desterilizing the data is used to convert the data into in-memory representation of the old protocol format. Then, the converted data is transformed in to the in-memory presentation of the new protocol format for use by the upgraded process. When the upgraded process sends data to the un-upgraded process, the in memory representation of the data in new protocol format is first transformed into the in-memory representation of the old protocol format. The old protocol for serializing data is then used to convert it into the old protocol format understood by the un-upgraded process.

### FIELD OF THE INVENTION

The present invention generally relates to the field of computer software, and particularly to a method to provide interoperability of different version protocols.

### BACKGROUND OF THE INVENTION

In a distributed system, processes communicate via a common protocol. As the protocol evolves, processes are upgraded to make use of a new protocol. However, upgrading a process is not always desirable because upgrading may cause inherent instabilities among processes. Further, upgrading of all processes in a distributed system may incur unnecessary cost. As a result, it is common that some processes are upgraded and some are not in a distributed system. When an upgraded process and an un-upgraded process communicate with each other, the upgraded process may need to tolerate the protocol used by the un-upgraded process.

Conventionally, a version number of protocol has been exchanged between two processes before they start communicating. As such, each process has prior knowledge of the protocol version being used by other processes. In order to maintain interoperability between upgraded and un-upgraded processes, protocol source codes are often changed. For example, the serialization/de-serialization code of the upgraded process may be changed in order to send and receive data in the old protocol format employed by the un-upgraded process. However, this approach assumes that there is ready access to the source code that performs serialization. This is not always true. For example, protocols that use the JAVA serialization may allow compatible changes in the in-memory representation of the data being transferred. In the JAVA environment, an extension mechanism may allow a user to write program codes to handle portions of the serialization/de-serialization. Sometimes, the changes are so incompatible as to violate the assumptions built into Java serialization, including the extension mechanism. In such a case, there is no easy means to preserve compatibility. One way to preserve compatibility may be to change the Java serialization itself in the upgrade process, which is usually not possible. Another way is to upgrade all processes, which may not be practical for reasons described earlier.

Therefore, it would be desirable to provide a method and system to preserve interoperability among processes with different version protocols. It would be also desirable to provide a method and system to provide interoperability among processes without access to protocol specific source code.

### SUMMARY OF THE INVENTION

Accordingly, the present invention provides a method and system to preserve interoperability through transformation of in-memory representation of different versions of the same data without modifying the previous version protocol source code.

In a first aspect of the present invention, a method of preserving interoperability between a first process with a first protocol and a second process with a second protocol is provided. The second protocol is an upgraded version of the first protocol and the second process is capable of processing both an updated data format and an un-updated data format. When the second process receives data from the first process, the first protocol may be utilized to de-serialize the data. Then, the data may be converted into in-memory presentation of the un-updated data format. The converted data may be transformed into in-memory representation of the updated data format suitable for being understood by the second process. In this manner, the interoperability of the un-updated protocol can be preserved without requiring accessing a protocol source code.

In a further aspect of the present invention, a method of preserving interoperability between a first process and a second process when the second process sends data to the first process is provided. The second protocol is an upgraded version of the first protocol and the second process may be capable of processing both updated data format and un-updated data format. Further, the second process may be capable of transforming between in-memory representation of both an un-upgraded data format and an upgraded data format. The second process may transform in-memory representation of the data from the upgraded data format to the un-upgraded data format. The first protocol may be utilized to serialize the in-memory representation of the data. During serialization, the in-memory representation of the un-upgraded format data may be converted into a proper data structure for the first protocol. The converted data may be sent to the first process. As such, the interoperability of the first process may be preserved.

In an advantageous aspect of the present invention, all processes in a distributed system may not have to be upgraded in order to communicate with each other. Further, the upgraded process may not have to change its protocol source code to accommodate un-upgraded protocol.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a flow diagram of a method implemented when an upgraded process receives data from an un-upgraded process in accordance with an exemplary embodiment of the present invention;

FIG. 2 is an illustration of a flow diagram of another method implemented when an upgraded process sends data to an un-upgraded process in accordance with an exemplary embodiment of the present invention;

FIG. 3A is an illustration of a block diagram of changes of the data format in the upgraded process in FIG. 1 in accordance with an exemplary embodiment of the present invention; and

FIG. 3B is an illustration of a block diagram of changes of the data format in the upgraded process in FIG. 2 in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

The present invention is directed to a method and system to preserve interoperability among processes in a distributed system through transformation of in-memory representation of different versions of the same data. The present invention does not require modifying the previous version or the current version protocol source code. In the following description, numerous specific descriptions are set forth in order to provide a thorough understanding of the present invention. It should be appreciated by those skilled in the art that the present invention may be practiced without some or all of these specific details. In some instances, well known process operations have not been described in detail in order not to obscure the present invention.

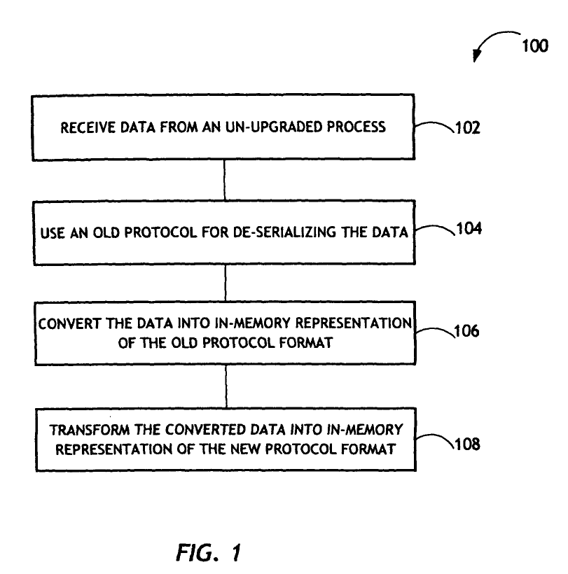

Referring generally now to FIGS. 1 through 3B, exemplary embodiments of the present invention are shown.

Referring to FIG. 1, a flow diagram 100 of a method implemented when an upgraded process receives data from an un-upgraded process in accordance with an exemplary embodiment of the present invention is shown.

In Step 102, an upgraded process may receive data from un-upgraded process. It is to be noted that the upgraded process may have means to determine a version number of the protocol that the un-upgraded process currently utilizes. There are various ways to provide version information of protocol to other processes. For example, the version information may be sent in a header, service context, or the like. The version information may be sent separately from the actual data being sent. If the actual data is divided into logical chunks, such as object boundaries in an object oriented system, the version information may be associated with each logical chunk of the data. In a particular embodiment of the present invention, a default version number may be assumed, if no version information is provided from the un-upgraded process. In Step 104, the upgraded process may utilize an old version protocol (un-upgraded protocol) to de-serialize the received data. The old version protocol has been determined by the version information.

Generally, de-serialization/serialization of data involves restructuring of the data. Serialization involves taking a data structure or object and encoding it into a regular and usually architecture-independent form, suitable for archival to a file, piping to another application, or, by extension, transmission across a network. Usually, the encoding takes the form of a byte stream (a sequence of bytes). When receiving a serialized stream of data, the encoding process may be reversed to get a copy of the original data structure. This is a de-serialization process. It should be appreciated by those skilled in the art that architecture independence must be maintained for serialization and de-serialization. Serializing the data structure in an architecture independent format may resolve the problems of byte ordering, memory layout, or simply different ways of representing data structures in different programming languages.

In Step 106, the data may be converted into an in-memory representation of the old data format (un-upgraded protocol format). Typically, when data is exchanged between processes, the received data may be parsed so that the content of the data is available in some form (e.g. in-memory representation form) for a process to manipulate. For example, when an XML (extensible Markup Language) Editor application receives an XML document, a parsing step may be required before the XML document is able to be processed by the XML Editor application. In some instances, Document Object Model (DOM) interface may be utilized to parse the XML document. The DOM interface is a programming interface specification developed by the World Wide Web Consortium (W3C), which parses an entire XML document and constructs a complete in-memory representation of the document using the classes modeling. After the DOM of the XML document is generated, the XML Editor may be able to display XML pages on the user's computer monitor. It is also well known to the art that parsing an XML document (representation) into an equivalent data structure suitable for being manipulated by an application is often called de-serialization, or un-marshalling. Similarly, writing a data structure to an equivalent XML representation is often called serialization or marshalling.

It is to be noted that the upgraded process is capable of processing the in-memory representation of both the un-upgraded protocol format and the upgraded protocol format. For example, in JAVA, Step 106 may be done by loading old classes and new classes through different class loaders that are not associated with each other. The old and new classes may be incompatible but have the same package and class name. In a particular embodiment of the present invention, the old and new classes may co-exist in the upgraded process. Each of the classes may have different in-memory representation. In Step 108, the in-memory representation of the old format (un-upgraded protocol format) data may be transformed into in-memory representation of the new format (upgraded protocol format) data. It is to be noted that the upgraded process comprises a means to transform between the in-memory representation of the un-upgraded protocol and the in-memory representation of the upgraded protocol. For example, in the JAVA environment, Step 108 may be done by using reflection to call methods to convert between the old and the new classes. In such a case, a change the in-memory representation of either the un-upgraded protocol or upgraded protocol to preserve JAVA serialization compatibility is not necessary.

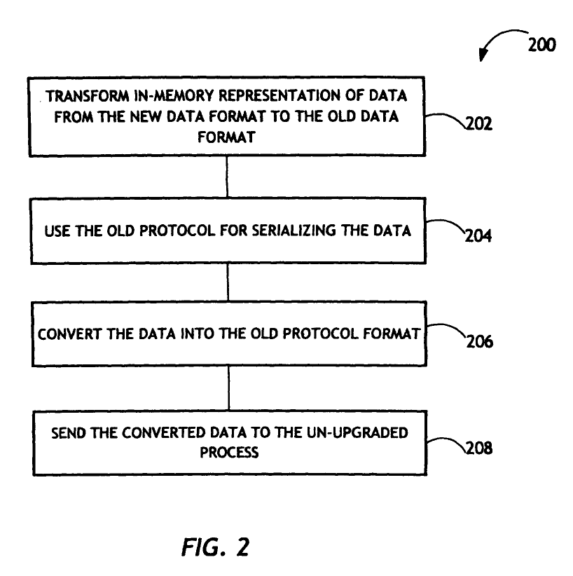

Referring to FIG. 2, a flow diagram 200 of a method implemented when an upgraded process desires to send data to an un-upgraded process in accordance with an exemplary embodiment of the present invention is shown. In Step 202, the upgraded process may transform the in-memory representation of data from the new format (upgraded protocol format) to the old format (un-upgraded protocol format). Then, the transformed in-memory representation of data may be serialized through the un-upgraded protocol in Step 204. As a result, the data may be converted into un-upgraded protocol format suitable for being understood by the un-upgraded process in Step 206. At this point, the data is ready to be sent to the un-upgraded process. The upgraded process may send the data to the un-upgraded process in Step 208. As described above, it should be appreciated that the upgraded process is capable of processing the in-memory representation of both the un-upgraded protocol format and the upgraded protocol format. However, the un-upgraded process does not have to be aware of whether the received data is sent from an upgraded process. Further, no modification of protocol source code may be required. In this manner, the interoperability among processes may be preserved without requiring processes to access of the protocol specific source code.

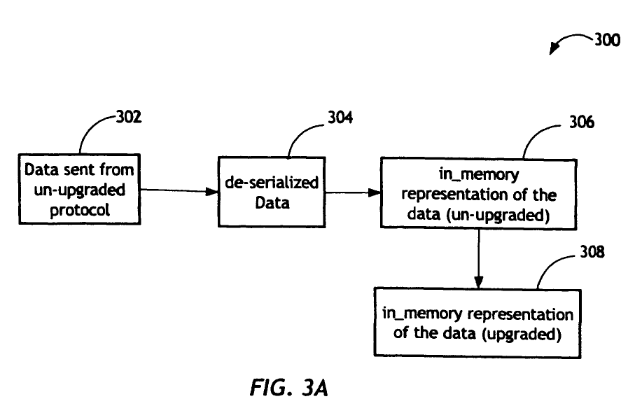

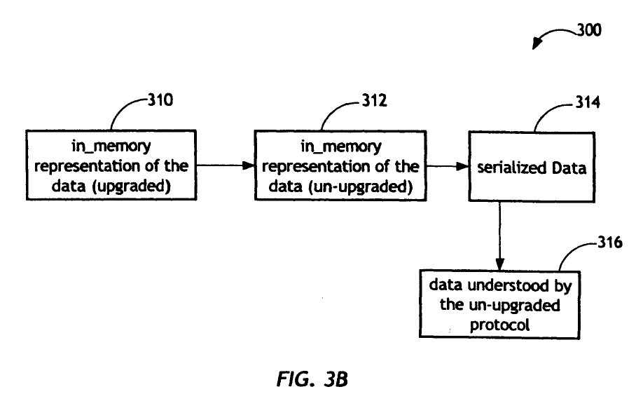

Referring now to FIG. 3A, a block diagram 300 of changes of the data format in the upgraded process in FIG. 1 is shown. When the upgraded process receives data 302 from the un-upgraded process, the old protocol (un-upgraded protocol) may be used for de-serializing the data 304. The data 304 may be converted into in-memory representation of the old protocol format 306. Then, in-memory representation of the old protocol format 306 is transformed in to the in-memory presentation of the new protocol format 308 suitable for being manipulated by the upgraded process.

Referring now to FIG. 3B, a block diagram 300 of changes of the data format in the upgraded process in FIG. 2 is shown. When the upgraded process desires to send data to the un-upgraded process, the in memory representation of the data in new protocol format 310 is first transformed into the in-memory representation of the old protocol format 312. The old protocol may be used for serializing the data 314. The serialized data 316 is in the old protocol format understood by the un-upgraded process.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the method and system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of preserving interoperability between a first process with a first protocol and a second process with a second protocol wherein the second process receives the data from the first process, comprising:
receiving data from the first process;
utilizing the first protocol to de-serialize the data;
converting the data into an in-memory representation of the first protocol format; and
transforming the in-memory presentation of the first protocol format to an in-memory representation of the second protocol format,
wherein the second protocol is an upgraded version of the first protocol and the second process is capable of processing both the second protocol and the first protocol.

2. The method as described in claim 1, further comprising:
determining a version of the first protocol of the first process.

3. The method as described in claim 2, wherein version information of the first protocol is sent in a header of the data.

4. The method as described in claim 2, wherein version information of the first protocol is sent in service context.

5. The method as described in claim 2, wherein version information of the first protocol is sent separately from the data.

6. The method as described in claim 2, wherein a default version number is utilized when the version of the first protocol is not determined.

7. A method for preserving interoperability between a first process with a first protocol and a second process with a second protocol wherein the second process sends data to the first process, comprising:
transforming an in-memory representation of data from a second data format to a first data format, serializing the data through the first protocol; and
converting the in-memory representation of the first data format into a data suitable for being understood by the first protocol,
wherein the second protocol is an upgraded version of the first protocol and the second process is capable of processing the second data format and the first data format.

8. The method as described in claim 7, wherein the second process is capable of transforming between in-memory representation of both the first data format and the second data format.

9. The method as described in claim 7, further comprising:
determining a version of the first protocol of the first process.

10. The method as described in claim 9, wherein version information of the first protocol is sent in a header of the data.

11. The method as described in claim 9, wherein version information of the first protocol is sent in service context.

12. The method as described in claim 9, wherein version information of the first protocol is sent separately from the data.

13. The method as described in claim 9, wherein a default version number is utilized when the version of the first protocol is not determined.

14. A system of providing interoperability between a first process with a first protocol and a second process with a second protocol wherein the second process receives the data from the first process, comprising:
means for receiving data from the first process;
means for de-serializing the data through the first protocol;
means for converting the data into an in-memory presentation of the first data format; and
means for transforming the in-memory presentation of the first data format into an in-memory representation of the second data format,
wherein the second protocol is an upgraded version of the first protocol and the second process is capable of processing the second data format and the first data format.

15. The system as described in claim 14, further comprising:
means for determining a version of the first protocol.

16. The system as described in claim 15, wherein version information of the first protocol is sent to the second process separately from the data.

17. A system for providing interoperability between a first process with a first protocol and a second process with a second protocol wherein the second process sends the data to the first process, comprising:
means for transforming in-memory representation of data from a second data format to a first data format,
means for utilizing the first protocol to serialize the data; and
means for converting the in-memory representation of the first data format into data suitable for the first protocol,
wherein the second protocol is an upgraded version of the first protocol and the second process is capable of processing the second data format and the first data format.

18. The system as described in claim 17, wherein the second process is capable of transforming between in-memory representations of both the first data format and the second data format.

19. The system as described in claim 17, further comprising:
means for determining the version of the first protocol of the first process.

20. The system as described in claim 19, wherein default version number is utilized when the version of the first protocol is not determined.
